(19) United States
(12) Patent Application Publication
(10) Pub. No.: US 2024/0311889 A1
(43) Pub. Date: Sep. 19, 2024

(54) PERSONALIZED ONE-OF-A-KIND GREETING CARDS WITH CUSTOM SUPERIMPOSED PHOTO IMAGES ONTO ARTWORK WITH APPLIQUES, MUSIC, SOUND, LIGHTS, MOVEMENT AND POP-UP DESIGNS

(71) Applicant: Carol Levy, New York, NY (US)

(72) Inventor: Carol Levy, New York, NY (US)

(21) Appl. No.: 18/436,016

(22) Filed: Feb. 7, 2024

Related U.S. Application Data
(60) Provisional application No. 63/483,755, filed on Feb. 7, 2023.

(51) Int. Cl. G06Q 30/0601

(52) U.S. Cl. CPC G06Q 30/0621; G06Q 30/0641

(57) ABSTRACT

Methods, systems and computer-readable medium for creating personalized greeting cards that provide a user interface through a website or mobile application for selecting one or more greeting card templates, enabling a user to upload personal images to superimpose onto one or more selected card templates, allowing customization of the greeting card with one or more embellishments such as jewels, sparkles, charms, bows, velvet, hearts, lace, and appliqués, incorporating one or more interactive features into the greeting card such as a music track, a sound track, a light, a mechanical movement, and a pop-up configured design, facilitating the addition of personalized text messages with one or more customization options selected from the following group: font, size, and color, generating a preview of the customized greeting card for the user's review, and producing the personalized greeting card for delivery to a designated recipient in one or more physical and/or digital version forms.

### CROSS-REFERENCES TO RELATED PATENT APPLICATIONS

This application claims the benefit of U.S. Provisional Application No. 63/483,755, filed on Feb. 7, 2023, the entire contents of which is incorporated herein by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND

Embodiments of the inventive subject matter relate to systems, apparatuses and methods for creating, analyzing, tracking and sending greeting cards and other related products and services using a computer enabled network such as the internet. Prior art greeting card issued patents include U.S. Pat. No. 7,359,954 entitled “Method and apparatus for distribution of greeting cards with electronic commerce transaction” to Friedman, et al.

### SUMMARY

The illustrative embodiments provide computer implemented methods, apparatuses, and systems implementing computer usable program code for allowing a user to choose from a plurality of raw products to draft and create greeting cards with various features including artwork/graphics on specific types of card stock and unique appliques such as jewels, sparkles, charms, bows, velvet hearts, lace, and the like. Other features may include three-dimensional card designs including pop-ups, tri-fold stand-up cards with and objects hanging and swinging on the cards, multiple page cards to customize that tell a story and look like a magazine or book, music, sounds, lights, and various moving elements.

Embodiments include methods, systems and computer-readable mediums for creating personalized greeting cards including providing a user interface through a website or mobile application for selecting one or more greeting card templates, enabling a user to upload personal images to superimpose onto one or more selected card templates, allowing customization of the greeting card with one or more embellishments selected from the following group: jewels, sparkles, charms, bows, velvet, hearts, lace, and appliqués, incorporating one or more interactive features into the greeting card selected from the following group: a music track, a sound track, a light, a mechanical movement, and a pop-up configured design, facilitating the addition of personalized text messages with one or more customization options selected from the following group: font, size, and color, generating a preview of the customized greeting card for the user's review, and producing the personalized greeting card for delivery to a designated recipient in one or more physical and/or digital version forms.

Other embodiments allow an option for the user to select one or more audio files from a predefined audio file library which are then incorporated into the greeting card as an audio feature including one or more effects from the following group: background music and sound effects. Other embodiments have the one or more audio files are selected from one or more of the following: a predefined audio file library and the user's uploaded audio file. Other embodiments allow the user to adjust the placement, size, and orientation of one or more personal images or embellishments on one or more greeting card templates. Other embodiments allow the user to integrate one or more lighting elements into the design of the greeting card. The user can also optionally customize the color and pattern of the lights. Other embodiments allow the user to configure an augmented reality (AR) feature that, when scanned by a mobile device, displays a virtual pop-up or animation overlaying a physical personalized greeting card.

Some embodiments also allow the user to add one or more scent-emitting elements to the personalized greeting card and other embodiments allow the user to select one or more scents from a pre-determined selection of one or more fragrances.

Many embodiments also allow user to use a social sharing feature so the user can share a digital version of the customized greeting card via a link, social media or via an email. Some embodiments include a system for creating personalized greeting cards including a server configured to host a website or a mobile application providing access to a library of greeting card templates, a user interface for uploading and editing images so that the images can be added by a user to one or more selected card templates, a customization module for adding embellishments and interactive features to a customized greeting card, a text editing tool for allowing the user to compose one or more personalized messages with one or more customizable text, fonts, sizes, and colors, a preview generator for displaying a representation of the customized greeting card; and a printing and delivery management system for creating physical copies of the customized greeting card and coordinating delivery to one or more specified recipients.

Some of these embodiments have the printing and delivery management system able to create non-physical copies of the customized greeting card and coordinate delivery to one or more specified recipients. Some of the embodiments can have the printing and delivery management system use a tracking feature that allows one or more users to monitor the production status and the delivery progress of the one or more customized greeting cards.

Many embodiments also allow the option for the user to select one or more audio files from a predefined audio file library which are then incorporated into the greeting card as an audio feature. These audio files can include one or more effects from the following group: background music and sound effects. In some of these embodiments, the one or more audio files are selected from one or more of the following: a predefined audio file library and the user's uploaded audio file.

In some embodiments, the text editing tool further allows the user to adjust the placement, size, and orientation of one or more images or embellishments on one or more greeting card templates. In many of the embodiments, the text editing tool further allows the user to integrate one or more lighting elements into the design of the greeting card so the user can customize the color and pattern of the personalized greeting card. Some embodiments include a text editing tool that allows the user to configure an augmented reality (AR) feature that, when scanned by a mobile device, displays a virtual pop-up or animation overlaying a physical personalized greeting card.

Embodiments also include a computer-readable medium containing program instructions executable by a processor for performing a method of creating one or more personalized greeting cards, the method including instructions for providing a selection interface for allowing a user to select one or more greeting card designs and templates, instructions for allowing the user to upload and edit images for superimposition on one or more selected templates, instructions for allowing the user to add and custom embellishments and interactive features on the one or more personalized greeting cards, instructions for allowing the user to enter and customize a personal message for inclusion in the one or more personalized greeting cards, instructions for generating a preview of the customized greeting card, and instructions for processing orders for physical or digital copies of the personalized greeting card, including delivery coordination.

Some of these embodiments further include instructions for a feedback mechanism that collects user preferences and suggestions for future greeting card designs, embellishments, and features, using machine learning algorithms to improve the customization options available and some of the embodiments include program instructions for allowing the user to add one or more scents to the one or more physical personalized greeting cards.

In many embodiments, examples include various methods and systems to personalize greeting cards. For example, instead of just signing and sending someone a card that can be purchased in a greeting card store, the inventive subject matter allows a user to personalize any card. In one example, a photo of the subject person, usually the recipient who will be featured in the card, if first proportionally sized to match the size of the character on the printed card and/or fit properly into the setting depicted on the card, thus making the person into the character depicted on the card. Second, an appropriately sized person is cut out from the photo, sometimes just the head or face, perhaps with other family or friends, depending on the artwork on the card and the number of individuals illustrated. Third, the subjects' heads and/or their bodies are superimposed and then glued to cover the existing heads and/or bodies that appear on the card. In another manner, the subject's heads and/or their bodies are placed in the setting of the card, thereby making the recipient the character in the card. In one example, in a card featuring Superman with lights and sounds, a subject brother can be transformed into the super-hero by adding his head to the top of the super-hero's body.

In another exemplary embodiment, a daughter is transformed into a Sleeping Beauty figure representing a beautiful princess with sparkling jewels by adding an image of the daughter's head to the top of the Sleeping Beauty's body.

In another example, the bride and groom are shown in a card on top of a wedding cake with bows and lace appliques, and the user that created the card and others of the user's choosing suddenly appear to be the figures sitting atop the cake in wedding attire.

In another example, a user creates a musical pop-up card featuring a singing, shaking Elvis Presley with the user's uncle avatar or picture in the place of the Elvis.

In another example, a card shows scenery from Venice, Italy as the background. The user/card creator's friends appear to suddenly appear on the gondola boat celebrating their anniversary!

In many of these examples, the cards can be further customized by embellishing them with unique appliques such as sequins, jewels, beads, ribbons, charms, lace, hearts, etc., resulting in every card being a one-of-a-kind work of art that is unique and extraordinary. For example, once a person's head (photo) is added to the top of the character depicted on the card, a graduation hat may be added atop, a crown, a wedding veil, a fishing hat, a baseball cap, glasses, etc. The end result is that the card becomes a gift in its own right, a three-dimensional keepsake that the recipient will save and place on a shelf as a cherished memory of the event being celebrated.

In many of the embodiments, the cards may include matching lined envelopes, gold seals, visuals of people, places, and animals. In many of the embodiments, a user will be able to superimpose a headshot and/or body of the chosen person(s) to be featured in the selected card. In this embodiment, the chosen person(s) will take the place of the existing character/person(s) on the card, and be placed in unique settings, making it look as though the person(s) becomes the star(s) of the card, and the story becomes a uniquely personalized story with their own images.

Additionally, users may select a message provided on the website, in addition to composing their own note and adding their names/signatures, choosing fonts, sizes and colors, or order it blank to write by hand. In many of the embodiments, users may have the cards sent to them or directly to the recipient, and the user can designate the card to arrive by a certain date, thereby allowing the user to preorder all the yearly cards in advance that they normally purchase. Ultimately, the user can create a greeting that captures memories so artistically personalized and customized and of such high quality, that the card transforms into a treasured personalized gift that is worthy of being put on display and never thrown away.

### DETAILED DESCRIPTION OF THE DRAWINGS

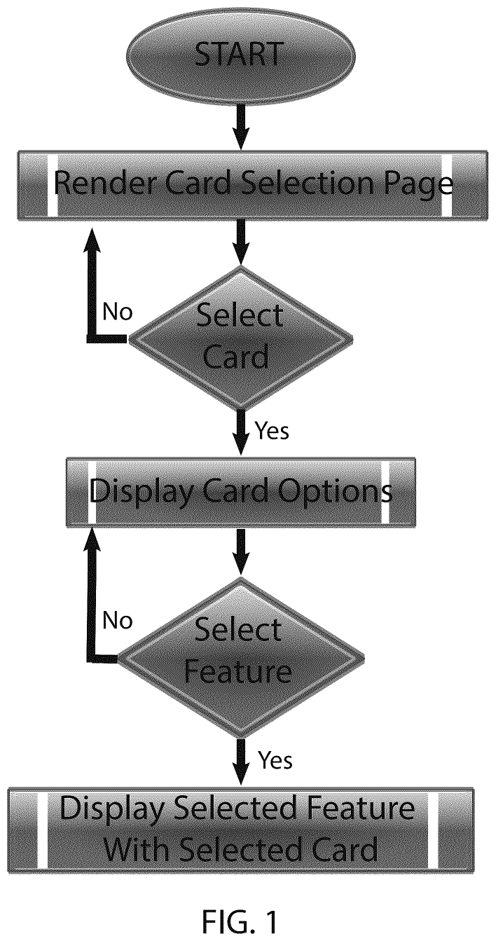

FIG. 1 shows an exemplary flow chart according to embodiments of the inventive subject matter;

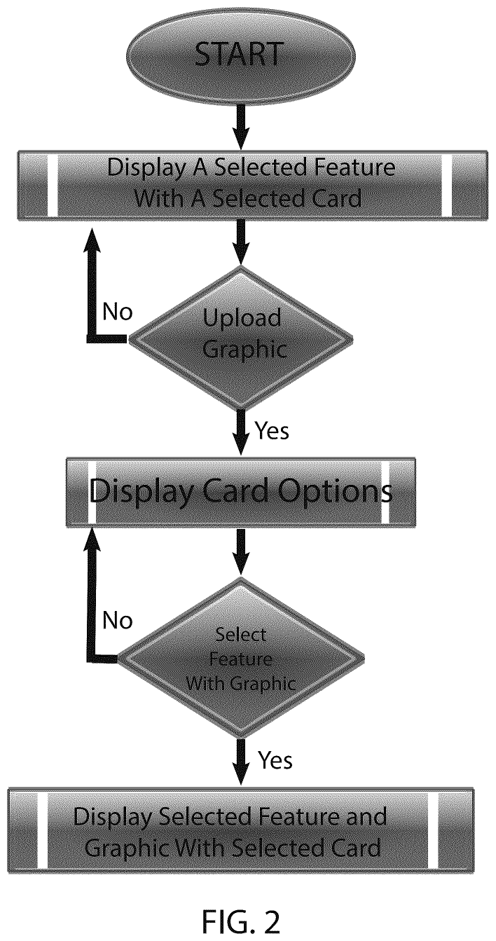

FIG. 2 shows another exemplary flow chart according to embodiments of the inventive subject matter; and

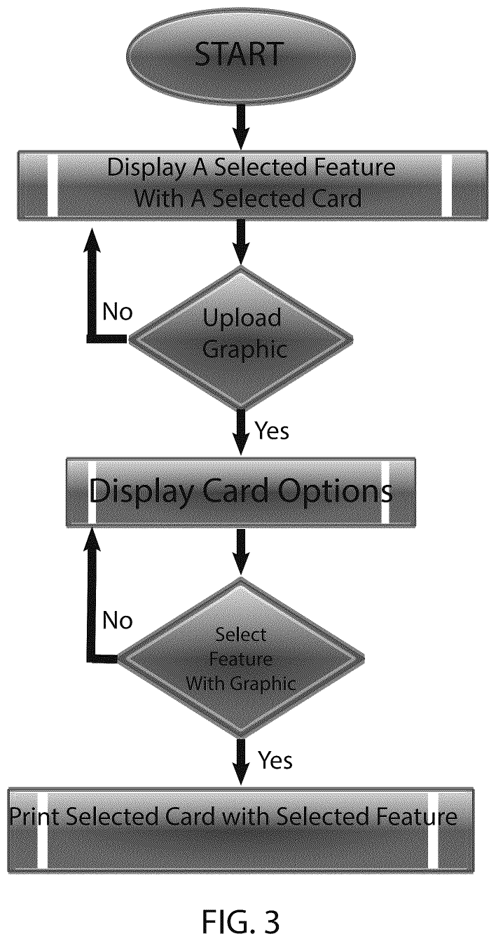

FIG. 3 shows another exemplary flow chart according to embodiments of the inventive subject matter.

### DETAILED DESCRIPTION OF THE EMBODIMENTS

According to embodiments of the claimed subject matter, various apparatuses, systems and methods systems for allowing users to create customized, personalized photo cards.

In accordance with an exemplary implementation of the inventive subject matter a method is provided for allowing users to access a website or app to draft and create a one-of-a-kind personalized artistic card with unique embellishments and features in which the recipient becomes the character, thereby making the card into a treasured gift and keepsake.

In many of the embodiments, the first step is for the user to enter a website, register, and log in. In the second step, the user selects a card, for example a high quality printed card on heavy card stock, that the user wants to personalize and send to the recipient, choosing from striking designs with unique appliques such as jewels, charms, beads, ribbons, lace, hearts, etc., cards with pop-up styles, sounds, movement, and lights when the card opens or a button is pressed, etc., and additional artwork will be inside of the card, as well, where photos may also be added.

In the next step, the user uploads any photos and headshots she or he wants to consider using and those uploads are subsequently store on the website's server for future use.

Fourth, the user superimposes the photo of the person or persons onto the area of the card that will display the image(s), either their headshot(s) or entire body(ies) depending on the design and individuals depicted in the scene. The personal images/photos may be applied to the cover and also on the inside of the card as determined by the card design.

Fifth, once the photos are added/superimposed, the user has the option of either a) having the card printed with the text as it appears on the card and sent directly to himself or herself so that they can inscribe the card personally and send it to the recipient, or b) they can have their signature added digitally to the card and mailed directly to the receiver, or c) they can add their own personalized text incorporated onto the card, along with their signature, by choosing from a selection of fonts, sizes and colors that can be printed onto the card, or d) they can write a personal note in their own handwriting, which then gets digitally added to the card, and e) they can choose to have the card left blank to fill in a hand-written note.

Next, the user may enter the recipient's address in order to mail the finished card directly to the receiver, which allows for further customization of the envelope, and even a customized/personalized stamp, or the card may be mailed to the user to be given to the recipient in person.

FIGS. 1-3 show exemplary flowcharts of the card creation and printing process according to embodiments of the inventive subject matter.

Other embodiments include the ability of the user to embed audio on a card so that the audio message is played when the card is opened or a button on the card is depressed.

In other embodiments, the user and/or the user can create an audio/recording on a card.

In other embodiments, the user can program a card to move in one to more specific manners when opened or a button is pushed on the card. In some of these embodiments, these movements can be previews by the user on the website. In many of these embodiments, a 3-D view can be presented to the user allowing her or him to view and zoom into the previous of the card.

Other embodiments include the ability of the user to use handwriting for a custom note and/or signature (for example with the use of a feature found on the paperwoven.com website.)

Other embodiments include the ability to design and send a card printed and mailed in a blank format on the main card page so the user or another person can write their own a note and sign the card.

Other embodiments include the ability for the card to either be sent to the user/customer or to a third party recipient. Cards may be purchased so that they are sent out to one or more recipients with messages throughout a period of time such as one year on designated dates.

Other embodiments include the ability to create photo stamps utilizing photos uploaded by the user.

In many of the embodiments, additional products may be sent instead of or in addition to one or more cards, for example digital cards sent over the internet, invitations, and boxed cards which are often used for special occasions.

In addition, the embodiments may use a rollover/zoom feature for the design of the one or more cards. These can show the individual cards in 2D or in 3D as some cards include “pop-ups” or “tri-fold” and movement features. The user can also previous any other feature such as sound, for example when the use records his or her own message and requests an audio or video review of the audio or multimedia recording.

In some embodiments, each card design and features/embellishments may not be changeable by the user, although a user can to add his or her photo(s) and audio (music or voice) to the specific types of card designs, for example a user may add audio to card designs that offer audio functionality.

Many of the three-dimensional card designs can include pop-ups, tri-fold stand-up cards with and objects hanging and swinging on the cards, multiple page cards to customize that tell a story and look like a magazine or book, music, sounds, and/or the use of lights or light emitting components. Many of these embodiments may also utilize various moving elements.

In many of the embodiments, cards with 3D unfolding greeting card components are cards that feature a design or image that appears to be three-dimensional when the card is opened. This effect can be achieved through the use of folds and cutouts in the card stock. In an exemplary embodiment, to create the 3D effect, the designer first creates a 2D design or image that will be used on the card. This design is then printed onto the card stock and cut out using a laser or die-cutting machine. The card stock is then folded and scored in specific places to create the desired 3D shape when the card is opened.

When the recipient receives the card and opens it, the 3D design will pop out of the card, giving the illusion of depth and dimension. In some embodiments, the 3D greeting cards also have moving parts, such as pop-up elements or rotating wheels, that add to the interactive nature of the card.

In many of the embodiments, moving elements can be added to greeting cards in a number of various ways. For example, pop-up elements are raised elements that are attached to the card by a hinge or pivot point, allowing them to pop up when the card is opened. Pop-up elements can be made using a variety of materials, including card stock, paper, foam, or plastic.

Sliders are elements that move back and forth along a track on the card. Sliders can be made using a variety of materials, including card stock, paper, foam, or plastic.

Spinners are elements that rotate around a central axis when the card is moved or touched. Spinners can be made using a variety of materials, including card stock, paper, foam, or plastic.

Flaps are hinged elements that can be lifted or moved to reveal hidden images or messages. Flaps can be made using a variety of materials, including card stock, paper, foam, or plastic.

Pull-tabs are elements that can be pulled out of the card to reveal hidden images or messages. Pull-tabs can be made using a variety of materials, including card stock, paper, foam, or plastic.

In the described embodiments, the user/designer first creates a design or image that will be used on the card optionally adding one or more of these elements to a greeting card. The design is then printed onto the card stock and cut out using a laser or die-cutting machine. The moving elements are then attached to the card using glue, tape, or other adhesives.

In many of the embodiments, additional reviews/ratings can be included with each card. The reviews and/or ratings in these embodiments can be integrated into a post-purchase campaign to elicit reviews and/or ratings from users allowing the website to quickly build reviews and credibility.

In many of the embodiments, the cards or other related products can be designed and ordered through a browser plugin or a downloadable application such as a mobile phone or tablet application.

In many of the embodiments, the system can be integrated with existing with e-Commerce platforms such as WooCommerce and Shopify as well as websites using SSL standards for secure, PCI compliant platforms.

In many of the embodiments, the system can be integrated with shipping companies, for example so that all post-purchase communications developed including confirmation, shipping notification, tracking is sent to the shipping company for order fulfillment and follow up purposes.

In some embodiments, larger poster versions of the cards may be used including cards with embellishments and various features, for example a feature that allows a user to upload a photo.

In these embodiments, the card can be optionally used in the form of a tri-fold display poster that stands. In use, the larger poster design embodiments use heavier cardboard that can be useful for larger gatherings and celebrations, for example they can be used with wedding party displays, graduation parties, remembrance displays at a memorial/funeral, retirement party, bar mitzvah/bat mitzvahs, and the like.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiment. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

What is claimed is:

1. A method for creating personalized greeting cards, comprising:
providing a user interface through a website or mobile application for selecting one or more greeting card templates;
enabling a user to upload personal images to superimpose onto one or more selected card templates;
allowing customization of the greeting card with one or more embellishments selected from the following group: jewels, sparkles, charms, bows, velvet, hearts, lace, and appliqués;
incorporating one or more interactive features into the greeting card selected from the following group: a music track, a sound track, a light, a mechanical movement, and a pop-up configured design;
facilitating the addition of personalized text messages with one or more customization options selected from the following group: font, size, and color;
generating a preview of the customized greeting card for the user's review; and
producing the personalized greeting card for delivery to a designated recipient in one or more forms selected from the following group: a physical and a digital version.

2. The method of claim 1, further comprising the step of allowing an option for the user to select one or more audio files from a predefined audio file library which are then incorporated into the greeting card as an audio feature including one or more effects from the following group: background music and sound effects.

3. The method of claim 2, wherein the one or more audio files are selected from one or more of the following: a predefined audio file library and the user's uploaded audio file.

4. The method of claim 1, further comprising allowing the user to adjust the placement, size, and orientation of one or more personal images or embellishments on one or more greeting card templates.

5. The method of claim 1, further comprising allowing the user to integrate one or more lighting elements into the design of the greeting card and further allowing the user to customize the color and pattern of the lights.

6. The method of claim 1, further comprising allowing the user to configure an augmented reality (AR) feature that, when scanned by a mobile device, displays a virtual pop-up or animation overlaying a physical personalized greeting card.

7. The method of claim 1, further comprising allowing the user to add one or more scent-emitting elements to the personalized greeting card.

8. The method of claim 7, wherein the scents are selected from a pre-determined selection of one or more fragrances.

9. The method of claim 1, further comprising a social sharing feature that allows the user to share a digital version of the customized greeting card via a link, social media or via email.

10. A system for creating personalized greeting cards, comprising:
a server configured to host a website or a mobile application providing access to a library of greeting card templates;
a user interface for uploading and editing images so that the images can be added by a user to one or more selected card templates;
a customization module for adding embellishments and interactive features to a customized greeting card;
a text editing tool for allowing the user to compose one or more personalized messages with one or more customizable text, fonts, sizes, and colors;
a preview generator for displaying a representation of the customized greeting card; and
a printing and delivery management system for creating physical copies of the customized greeting card and coordinating delivery to one or more specified recipients.

11. The system for creating personalized greeting cards of claim 10 wherein the printing and delivery management system is for creating non-physical copies of the customized greeting card and coordinating delivery to one or more specified recipients.

12. The system for creating personalized greeting cards of claim 10, wherein the printing and delivery management system further comprises a tracking feature that allows one or more users to monitor the production status and the delivery progress of the customized greeting card.

13. The system for creating personalized greeting cards of claim 10, further comprising the step of allowing an option for the user to select one or more audio files from a predefined audio file library which are then incorporated into the greeting card as an audio feature including one or more effects from the following group: background music and sound effects.

14. The system for creating personalized greeting cards of claim 13, wherein the one or more audio files are selected from one or more of the following: a predefined audio file library and the user's uploaded audio file.

15. The system for creating personalized greeting cards of claim 10, wherein the text editing tool further allows the user to adjust the placement, size, and orientation of one or more images or embellishments on one or more greeting card templates.

16. The system for creating personalized greeting cards of claim 10, wherein the text editing tool further allows the user to integrate one or more lighting elements into the design of the greeting card so the user can customize the color and pattern of the personalized greeting card.

17. The system for creating personalized greeting cards of claim 10, wherein the text editing tool further allows the user to configure an augmented reality (AR) feature that, when scanned by a mobile device, displays a virtual pop-up or animation overlaying a physical personalized greeting card.

18. A computer-readable medium containing program instructions executable by a processor for performing a method of creating one or more personalized greeting cards, the method comprising:
instructions for providing a selection interface for allowing a user to select one or more greeting card designs and templates;
instructions for allowing the user to upload and edit images for superimposition on one or more selected templates;
instructions for allowing the user to add and custom embellishments and interactive features on the one or more personalized greeting cards;
instructions for allowing the user to enter and customize a personal message for inclusion in the one or more personalized greeting cards;
instructions for generating a preview of the customized greeting card; and
instructions for processing orders for physical or digital copies of the personalized greeting card, including delivery coordination.

19. The computer-readable medium of claim 18, further including program instructions for a feedback mechanism that collects user preferences and suggestions for future greeting card designs, embellishments, and features, using machine learning algorithms to improve the customization options available.

20. The computer-readable medium of claim 18, further including program instructions for allowing the user to add one or more scents to the one or more physical personalized greeting cards.
